(19) United States
(12) Patent Application Publication
(10) Pub. No.: US 2006/0023049 A1
(43) Pub. Date: Feb. 2, 2006

(54) Inkjet printer

(76) Inventors: Yoshikazu Koike, Chino-shi (JP); Kaneo Yoda, Okaya-shi (JP)

Correspondence Address: HARNESS, DICKEY & PIERCE, P.L.C., P.O. BOX 828, BLOOMFIELD HILLS, MI, 48303, US

(21) Appl. No.: 11/175,999

(22) Filed: Jul. 6, 2005

(30) Foreign Application Priority Data
Jul. 7, 2004 (JP) 2004-200567

(51) Int. Cl. B41J 2/01

(52) U.S. Cl. 347/104

(57) ABSTRACT

An ink jet printer including fixed heads HD1 to HD5 which are arranged opposed to a recording surface PP of a recording medium P placed on a transporting belt V and transported. The ink jet printer has a recording area formed by arranging plural nozzles for ejecting ink droplets in a direction intersecting the transporting direction of the recording medium, wherein the transporting belt V has clogging preventing ejection openings WD1 to WD5 which are opposed to the fixed heads HD1 to HD5 at a predetermined time while the transporting belt V goes around, and the recording medium P is placed on the transporting belt V so as not to be laid on the clogging preventing ejection openings WD1 to WD5.

### FIELD OF THE INVENTION

The present invention relates to an ink jet printer provided with a fixed recording head, and particularly to prevention of clogging of a nozzle from which ink is ejected.

### BACKGROUND OF THE INVENTION

Recently, an increase of recording speed in an ink jet printer which ejects an ink droplet from a nozzle to perform recording on a recording medium has been required. Therefore, an ink jet printer (hereinafter referred to as a line head type ink jet printer) having a line type recording head (hereinafter, referred to as a line head) in which many nozzles are arranged throughout a length larger than a width of a recording medium has been put to practical use.

In such a line head type ink jet printer, a recording medium is transported continuously or intermittently so that its recorded surface is opposed to a surface on which a nozzle of the line head is formed. Further, the line head ejects, onto the recorded surface of the transported recording medium, ink droplets from the arranged many nozzles selectively on the basis of information to be recorded. Namely, in the line head type ink jet printer, without movement of the recording head and by only moving the recording medium in one direction, recording on the recording medium is completed. Hereinafter, in the specification, an ink jet printer in which recording is completed by a recording head that does not move, and only the recording medium moves, will generally be referred to as a line head type ink jet printer.

In not only the line head, but also the recording head in the ink jet printer, there is a case where a solvent of ink evaporates from the nozzle from which the ink droplet is ejected and a viscosity of the ink in the nozzle increases. In such a situation, the ink may harden or foreign matter may enter the nozzle. As such, a sitation arises wherein a clogging of the nozzle occurs. In this case, performance of ejecting the ink droplet from the nozzle is lowered. Therefore, the ink jet printer is so constituted that before the ejection performance lowers because of the increase of the ink viscosity in the nozzle or clogging, a clogging preventing ejection in which the ink droplet is ejected regardless of recording is performed thereby to maintain good quality recording capability.

In the conventional line head type ink jet printer, the technology that prevents the clogging that prevents ejection lengthens the time to complete recording, even in a case where recording is continuously performed on many recording mediums, has been known (for example, JP-A-2001-113690 (refer to page 6, and FIGS. 2 and 3)). In this technology, a plurality of openings are provided in a transporting belt which is laid between a pair of feed rollers and transports the recording medium, and the ink droplets are ejected through these plurality of openings.

However, in the above related art, the plurality of openings through which the ink droplets pass are provided in several points. Namely, during recording, the recording medium is laid on any opening, and the recording medium is distorted at its part which is laid on the opening. Therefore, between the recording medium part placed on the transporting belt and the recording medium part laid on the opening, the distance from the recording head is uneven. As a result, an impact position of the ejected ink droplet is shifted. Therefore, there is an unsolved problem that it is difficult to obtain good recording quality.

Further, in the above related art, the plurality of openings through which the ink droplets pass are spaced in the paper transporting direction and provided in the transporting belt. Namely, the plurality of openings in the transporting belt are, upon turning of the transporting belt, opposed to the nozzles of one recording head succeedingly. Therefore, the ink droplets cannot be temporarily ejected from all the nozzles of one recording head. As such, there is an unsolved problem where it is difficult to reduce the time necessary for a clogging preventing ejection of one recording head.

Further, in the above related art, in a case where the clogging preventing ejection is required in a state where recording is continuously performed on many recording mediums, it is necessary to perform the clogging preventing ejection after confirming that the paper does not exist on the plurality of openings of the transporting belt. Therefore, in a case where the paper exists on the plurality of openings of the transporting belt, there is an unsolved problem where the timing for clogging preventing ejection is delayed. As a means for solving this problem, the supply of the recording medium to the transporting belt may be stopped when the clogging preventing ejection is required. However, in such a case, the recording time necessary for the many recording mediums is delayed.

### SUMMARY OF THE INVENTION

The present invention has been made in order to solve the above problems. An object of the invention is to provide an ink jet printer which can obtain good recording quality, can reduce the time necessary for a clogging preventing ejection, and can reduce the time necessary for recording. The present invention achieves this even in a case where recording is continuously performed on many recording mediums, without delaying the timing for a clogging preventing ejection.

According to a first aspect of the invention, an ink jet printer is provided that includes a fixed head which is arranged opposite to a recording surface that is an opposing surface to a transporting surface of a recording medium placed on a transporting belt and transported. The ink jet printer has a recording area formed by arranging a plurality of nozzles for ejecting ink droplets in a direction intersecting the transporting direction of the recording medium. This ink jet printer is characterized in that the transporting belt has a clogging preventing ejection opening which is opposed to the recording head at a predetermined time while the transporting belt goes around. In this regard, the recording medium is placed on the transporting belt so as not to be laid on the clogging preventing ejection opening.

Hereby, because the recording medium is placed on the transporting belt to not be laid on the clogging preventing ejection opening, the distance from the recording head to the recording medium can be made uniform. Further, even in a case where recording is continuously performed on a plurality of recording mediums, the clogging preventing ejection opening can be opposed to the fixed head every time recording for one recording medium is completed.

Further, according to a second aspect of the invention, the ink jet printer is characterized by including an opening position detecting unit which detects a position of the clogging preventing ejection opening in the transporting direction, and a recording medium supply unit which supplies the recording medium on the transporting belt at the time in which the position detected by the opening position detecting unit comes on a downstream side of a supply position of the recording medium.

Hereby, the position of the clogging preventing ejection opening in the transporting direction can be detected, and the recording medium can be supplied onto the transporting belt in a state where this position exceeds the supply position of the recording medium, and the recording medium is not laid on the clogging preventing opening.

Further, according to a third aspect of the invention, the ink jet printer is characterized in that the opening position detecting unit comprises an index part formed at one side edge of the transporting belt, and an index sensor for detecting the index part.

Hereby, since the index part which the index sensor detects is formed at one side edge of the transporting belt, the opening position detecting unit can be constituted without obstructing transportation of the recording medium.

Further, according to a fourth aspect of the invention, the ink jet printer is characterized in that the index sensor comprises an optical sensor having a light emitting element and a light receiving element.

Hereby, the index sensor can detect, in a non-contact state, the index part formed at the transporting belt.

Further, according to a fifth aspect of the invention, the ink jet printer is characterized in that the fixed head is constituted such that a plurality of recording heads, each having a plurality of nozzles arranged throughout a predetermined length, are arranged in a direction that intersects the transporting direction of the recording medium. The plurality of clogging preventing ejection openings are arranged in a direction intersecting the transporting direction so that the openings, each of which is opposed to at least one of the plurality of recording heads, are simultaneously opposed to the plurality of recording heads constituting the recording area at the predetermined time.

According to the above constitution, the plurality of openings formed in the transporting belt can be opposed to the plurality of recording heads constituting the recording area at the same time.

Hereby, in a state where the plurality of recording heads constituting the recording area are opposed to the plurality of openings, the ink droplets ejected from all the nozzles of the plurality of recording heads at the same time, without attaching onto the transporting belt surface on which the recording medium is placed, can pass through the plurality of openings.

Further, according to a sixth aspect of the invention, the ink jet printer is characterized in that an opening is provided for each of the plurality of recording heads constituting the recording area.

Hereby, since the opening can be opposed to each recording head in the recording area constituted by the plurality of recording heads, the clogging preventing ejection in which the ink droplets are ejected regardless of recording can be controlled and executed for each recording head.

Further, according to the seventh aspect of the invention, the ink jet printer is characterized in that the opening is formed symmetrically with a center line in a width direction that intersects the transporting direction of the transporting belt.

According to the constitution, the clogging preventing ejection opening of the transporting belt, which is opposed to the fixed head at the predetermined time while the transporting belt goes around, is formed symmetrically with the center line in the width direction of the transporting belt. Therefore, even in a case where the predetermined tensile load is applied onto this transporting belt, any deformation of the transporting belt can be made symmetrical with the center line.

Hereby, it is possible to reduce a meandering phenomenon in which the transporting belt turns while moving in the width direction in transportation of the recording medium.

### BRIEF DESCRIPTION OF THE DRAWINGS

FIG. 1 is an external view showing the main constitution of an ink jet printer in an embodiment of the invention;

FIG. 2 is a diagram showing an appearance of a recording head;

FIG. 3 is a diagram for explaining a recording area of the ink jet printer in the embodiment of the invention;

FIG. 4 is a sectional view showing the constitution of an ink absorbing part;

FIG. 5 is a block diagram showing a control relation among main parts of the ink jet printer in the embodiment of the invention;

FIG. 6 is a diagram for explaining a recording operation of the ink jet printer in an embodiment of the invention;

FIG. 7 is a diagram for explaining the clogging preventing ejection of the ink jet printer in an embodiment of the invention;

FIG. 8 is a flowchart of a clogging preventing ejection processing between paper; and

FIG. 9 is a diagram showing another constitution of the recording head.

### DETAILED DESCRIPTION OF THE PREFERRED EMBODIMENTS

An embodiment of the invention will be described with reference to drawings.

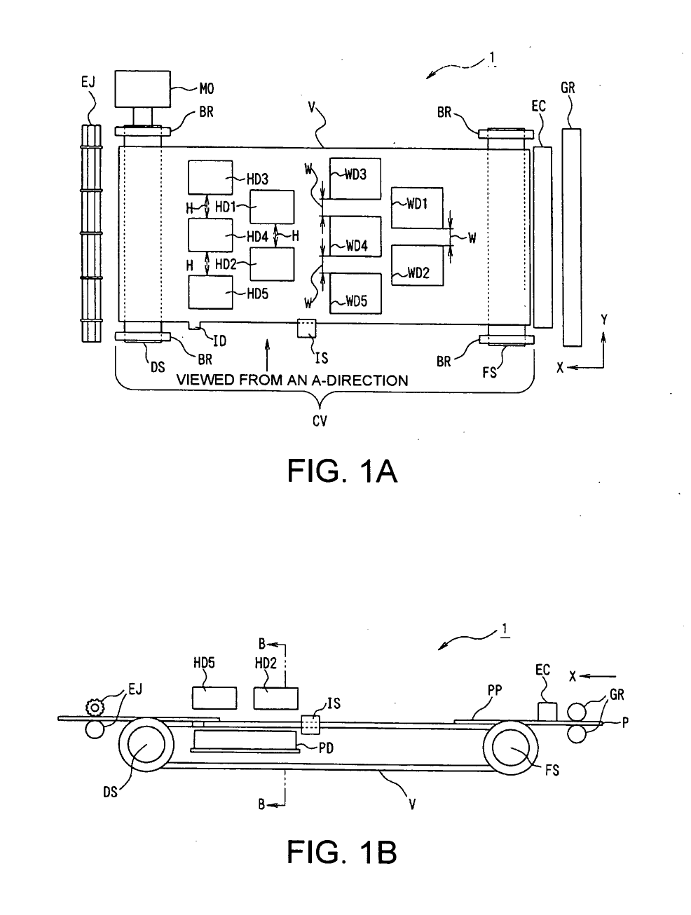

An ink jet printer 1 of the present invention, as shown in plain view in FIG. 1A, comprises a gate roller GR, a static electricity applying part EC, a paper transporting part CV, recording heads HD1-HD5, and a paper discharging part EJ. Further, ink jet printer 1, as shown in a front view in FIG. 1B, includes an ink absorbing part PD inside a transporting belt V which will be described later.

Here, the details of each component will be described.

The paper transporting part CV, as shown in FIG. 1A, comprises a drive shaft DS to which power is transmitted from a transporting part drive motor MO, a driven shaft FS which is arranged in parallel to the drive shaft DS and on the upstream side of the drive shaft DS, a transporting belt V laid between the drive shaft DS and the driven shaft FS, and bearings BR which hold, respectively, the drive shaft DS and the driven shaft FS rotatably in a housing (not shown).

Here, to the driven shaft FS, in order to apply tension power so that the transporting belt V laid between the drive shaft DS and the driven shaft FS does not slacken, power (not shown) is applied in the upstream direction.

The transporting belt V is turned by the power of the transporting part drive motor MO counterclockwise (FIG. 1B) to transport recording paper P placed on the transporting belt V in an X-direction (the transporting direction).

In the transporting belt V, as shown in FIG. 1A, opening parts WD1 to WD5, respectively corresponding to the recording heads HD1 to HD 5, are provided. These opening parts WD1 to WD5 are the same in shape and area of an opening. The opening parts WD1 and WD2, respectively corresponding to the recording heads HD1 and HD 2, are provided with a space W between each other adjacently to each other in a Y-direction that is orthogonal to the X-direction. On the downstream side in the X-direction of the opening parts WD1 and WD2, the opening parts WD3, WD4, and WD5, respectively corresponding to the recording heads HD3, HD4, and HD 5, are provided with a space W between each other adjacently in the Y-direction, and they are provided alternately with the opening parts WD1 and WD2 in the Y-direction.

Each opening part WD1 to WD5 is provided so as to be simultaneously opposed to each recording head HD1 to HD5 at a predetermined, time while the transporting belt V turns by the power of the transporting part drive motor MO.

Further, the paper transporting part CV includes an index sensor IS which outputs an index signal that becomes a reference for controlling the turn of the transporting belt V.

This index sensor IS is composed of an optical sensor having a light emitting element and a light receiving element, such as a photointerruptor. The index sensor IS detects an index part ID provided for the transporting belt V, and outputs an index signal which becomes an opportunity for taking time to supply the recording paper P onto the transporting belt V or to perform a clogging preventing ejection which will be described.

In the case where the recording paper P is supplied onto the transporting belt V, in order to prevent the recording paper P from being laid on the opening parts WD1 to WD5, it is supplied after the predetermined time has passed since the index signal was output from the index sensor IS.

Regarding the recording heads HD1 to HD5, as shown in FIG. 1A, the recording heads HD1 and HD2 are arranged with a space H between each other adjacently in the Y-direction. On the downstream side in the X-direction of the adjacent recording heads HD1 and HD2, the recording heads HD3 to HD5 are arranged with a space H between each other in the Y-direction, and alternately with the recording heads HD1 and HD2 in the Y-direction.

Further, these recording heads HD1 to HD5, as shown in FIG. 1B, are each arranged on the paper transporting part CV so that their nozzles from which ink droplets are ejected face onto a recording surface PP of the recording paper P.

Here, arrangement of the nozzles provided in the recording heads HD1 to HD5 will be described. Though the recording heads HD1 to HD5 are, for convenience of description, denoted by different reference numerals, they are the same. Herein, with the recording head HD1 as an example, the arrangement will be described.

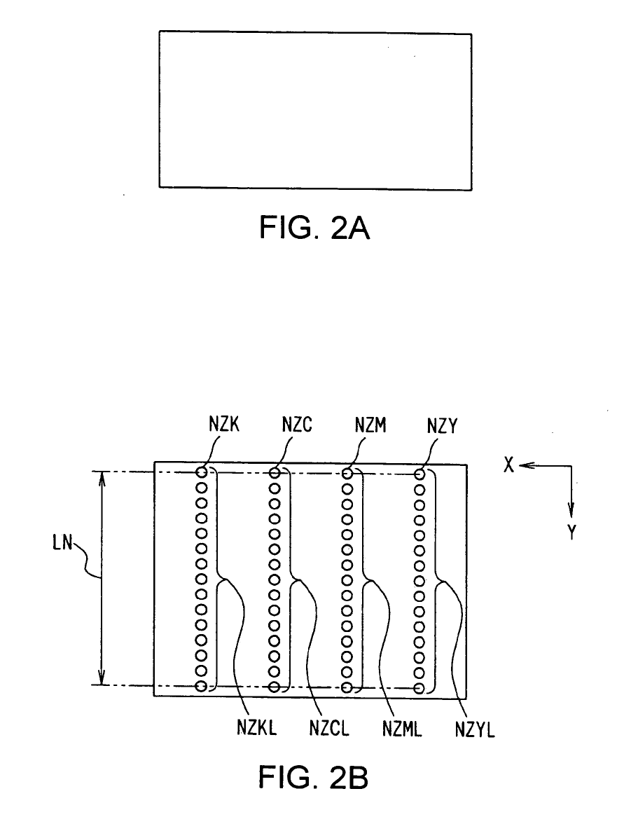

FIG. 2 is a diagram showing an appearance of the recording head HD1. FIG. 2A is a front view viewed from the A-direction in FIG. 1A. FIG. 2B is a bottom view. In FIG. 2, in order to show the nozzle plainly, the size of the nozzle is stretched and the number of the nozzles is reduced.

The recording head HD1, as shown in FIG. 2B, includes a yellow nozzle NZY from which yellow ink is ejected, a magenta nozzle NZM from which magenta ink is ejected, a cyan nozzle NZC from cyan ink is ejected, and a black nozzle NZK from which black ink is ejected.

The nozzles NZY, NZM, NZC, and NZK are arranged in the X-direction, and constitute a yellow nozzle array NZYL, a magenta nozzle array NZML, a cyan nozzle array NZCL, and a black nozzle array NZKL, each of which extend in the Y-direction with an arrangement length LN. The arrangement length LN of the nozzle array NZYL, NZML, NZCL and NZKL becomes a recording width of the recording head HD1.

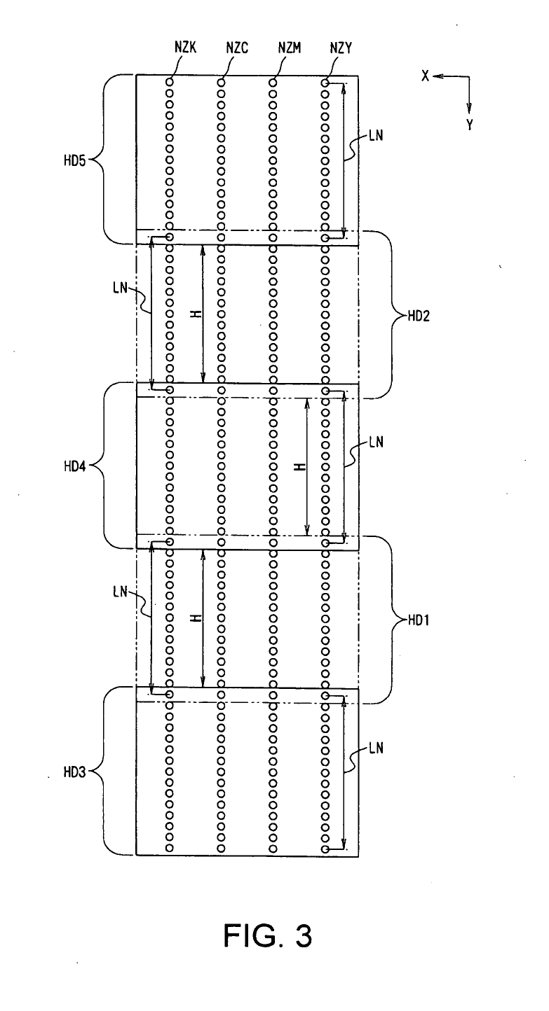

When the recording heads HD1 and HD2 shown in FIG. 1A are moved in parallel in the X-direction, and the recording heads HD1, HD2, HD3, HD4, and HD5 are aligned in the Y-direction, as shown in FIG. 3, the nozzle arrays NZYL, NZML, NZCL and NZKL of the recording heads HD1 to HD5 are aligned in the Y-direction, so that one nozzle array of each color is constituted. In FIG. 3, the recording heads HD1 and HD2 are shown by chain double-dashed lines.

Here, a relation between the space H between the recording heads, and the nozzles arrangement length LN is indicated by H<LN. Further, the recording heads HD1 and HD2, in positions of the nozzles at ends in the Y-direction, overlap with the recording heads HD3 to HD5, viewed from the X-direction. Namely, one nozzle array of each color in the recording heads HD1 to HD5 constitutes a recording area that extends to a distance at which the nozzle arrangement lengths LN of the number of the recording heads HD1 to HD5 (here, five) are aligned in the Y-direction.

Further, as the recording head HD1 to HD5, a recording head which applies pressure to the ink by a piezoelectric element or a heating element to eject an ink droplet can be adopted.

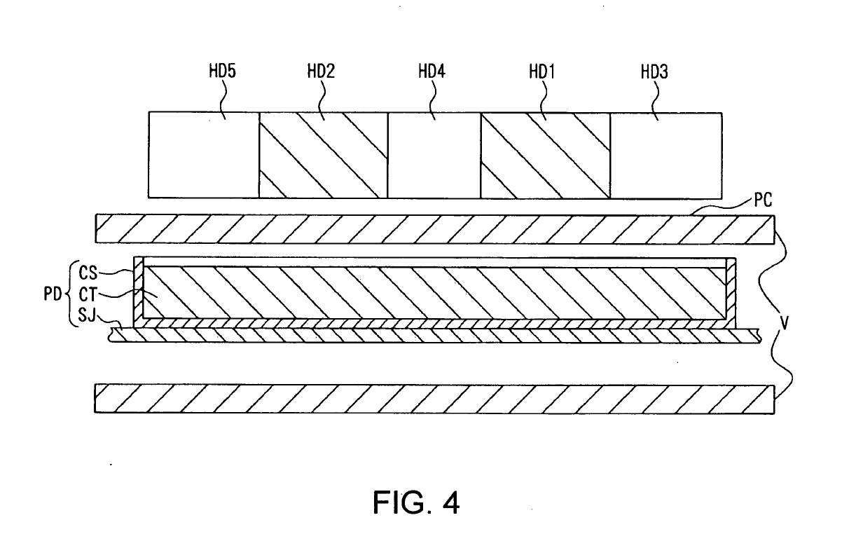

In the ink absorbing part PD, as shown in FIG. 4 in a schematic section taken along a line B-B in FIG. 1B, an ink absorber CT which absorbs ink obtained by the clogging preventing ejection (described later) is arranged, inside the transporting belt V, opposed to the recording heads HD1 to HD5. A transporting path PC of the recording paper P is disposed between the ink absorbing part PD and the recording heads.

This ink absorber CT is composed of material having a high capacity for absorbing liquid, such as a felt or a sponge, and is provided in a case CS arranged on a support plate SJ supported by a housing (not-shown). In FIG. 4, in order to facilitate understanding the downstream side in the X-direction from the drive shaft DS is omitted, and the detailed sections of the recording heads HD2 and HD1 are omitted.

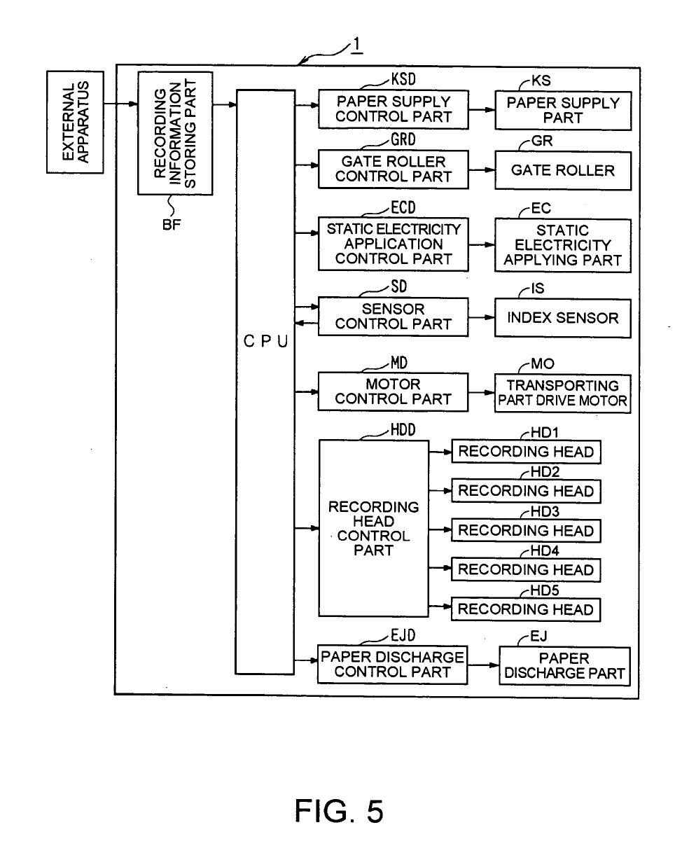

Now, a control relation among main parts of the above-mentioned ink jet printer 1 will be described with reference to FIG. 5.

As shown in FIG. 5, the ink jet printer 1 further includes, in addition to the above-mentioned components, a paper supply part KS which supplies the recording paper P to a gate roller GR. Further, the ink jet printer 1 includes a paper supply control part KSD which controls the paper supply part KS, a gate roller control part GRD which controls a gate roller GR, a static electricity application control part ECD which controls a static electricity applying part EC, a sensor control part SD which controls the index sensor IS, a motor control part MD which controls a transporting part drive motor MO, a recording head control part HDD which controls each recording head HD1 to HD5, a paper discharge control part EJD which controls a paper discharge part EJ, and a recording information storing part BF which stores recording information from an external apparatus, and CPU which gives operational instructions to each control part KSD, GRD, ECD, SD, MD, HDD, EJD.

Next, a recording operation in the ink jet printer 1 will be described below.

The ink jet printer 1 shown in FIG. 1, upon reception of recording information and recording instructions from an external apparatus, starts the recording operation.

When the recording operation is started, the CPU sends a transporting part drive instruction to the motor control part MD, and the transporting part drive motor MO is drive-controlled by the motor control part MD to turn the transporting belt V counterclockwise as shown in FIG. 1B.

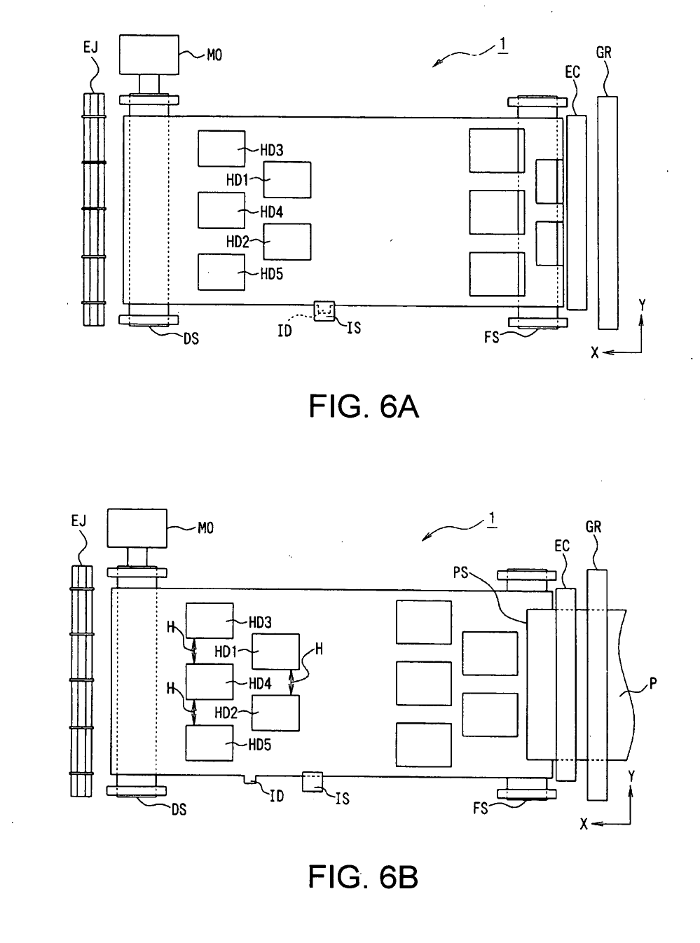

When the index part ID, as shown in FIG. 6A, interrupts an optical axis between the light emitting element and the light receiving element of the index sensor IS, an index signal is outputted from the index sensor IS to the CPU.

The CPU, upon receipt of the index signal, sends to the paper supply control part KSD a paper supply instruction that indicates supply of the recording paper P from the paper supply part KS to the gate roller GR, and starts counting the time necessary to supply the recording paper P from the gate roller GR onto the transporting belt V. The CPU also starts counting the time necessary for each recording head HD1 to HD5 to perform recording on the recording paper P.

The paper supply control part KSD, upon reception of the paper supply instruction from the CPU, controls the paper supply part KS, and causes the paper supply part KS to supply the recording paper P from a not-shown paper cassette in which a plurality of paper P is stored to the gate roller GR one by one.

The gate roller GR, upon receipt of the supplied recording paper P, corrects a tilt of the recording paper P in the X-direction, and corrects a registration error of the recording paper P in the Y-direction.

When the counted time comes to a paper supply time in which the supply of the recording paper P from the gate roller GR onto the transporting belt V is started, the CPU sends a paper supply instruction to the gate roller control part GRD. Here, the paper supply timing is set so that after the index sensor IS has output the index signal (FIG. 6A), the opening parts WD1 to WD5 move in the X-direction with the turn of the transporting belt V, and the recording paper P is placed on the transporting belt V so as to get out of the opening parts WD1 to WD5 (FIG. 6B). Namely, the recording paper P is set on the transporting belt V at a time in which the positions of the opening parts WD1 to WD5 exceed the supply position shown in FIG. 6B at which a leading end PS of the recording paper P comes onto the transporting belt V.

While the recording paper P is placed onto the transporting belt V, the static electricity application control part ECD controls the static electricity applying part EC on the basis of the instructions from the CPU to charge the recording paper P.

The recording paper P which obtains absorbability onto the transporting belt V by a charge that is absorbed is driven by the transporting part drive motor MO on a peripheral surface of the transporting belt V and guided to the downside of the recording heads HD1 and HD2.

Next, the CPU, when the counted time comes to a time in which recording is started by the recording heads HD1 and HD2, sends a first recording instruction to the recording head control part HDD.

The recording head control part HDD, on the basis of the first recording instruction, controls the recording heads HD1 and HD2 and causes the recording heads HD1 and HD2 to eject ink droplets selectively on the recording surface PP of the recording paper P which is continuously moved under the nozzle surface NZP by the transporting belt V. The ink droplets are ejected from the nozzles NZY, NZM, NZC, and NZK of each color on the basis of the recording information, whereby a first recording is performed.

The recording paper P on which the first recording has been performed is further transported by the transporting belt V, and guided under the recording heads HD3 to HD5.

Next, the CPU, when the counted time comes to a time in which recording by the recording heads HD3 to HD5 is started, sends a second recording instruction to the recording head control part HDD.

The recording head control part HDD, on the basis of the second recording instruction, controls the recording heads HD3 to HD5 in a similar manner to the case in the first recording, and causes the recording heads HD3 to HD5 to execute second recording.

Upon completion of the second recording, recording on one recording paper P is completed, and the recording paper P is discharged to the outside of the ink jet printer 1 by the paper discharge part EJ which the paper discharge control part EJD controls.

In a case where recording for all the recording information is completed, the recording operation ends; and in a case where unrecorded recording information remains, new recording paper P is supplied to the gate roller GR at the above paper supply time and the recording operation is continued until recording for all the recording information is completed.

Next, an operation for the clogging preventing ejection in the ink jet printer 1 will be described below. Here, the clogging preventing ejection is performed in order to prevent clogging by ejecting ink droplets from the nozzle, regardless of recording, before ejection performance lowers because of an increase of ink viscosity in the nozzle and clogging.

The operation of the clogging preventing ejection is started when the power supply of the ink jet printer 1 is turned ON from OFF, when the power supply of the ink jet printer 1 is ON and the predetermined time passes without recording, or when the user gives an instruction of this operation arbitrarily.

When operation of the clogging preventing ejection is started, the CPU sends a transporting part drive instruction to the motor control part MD, and the transporting part drive motor MO is drive-controlled by the motor control part MD so as to turn the transporting belt V counterclockwise, as shown in FIG. 1B.

As shown in FIG. 6A, when the index part ID interrupts, the optical axis between the light emitting element and the light receiving element of the index sensor IS, an index signal is outputted from the index sensor IS to the CPU.

The CPU, upon receipt of the index signal, starts counting the time required till each opening part WD1 to WD5 is opposed to each recording head HD1 to HD5.

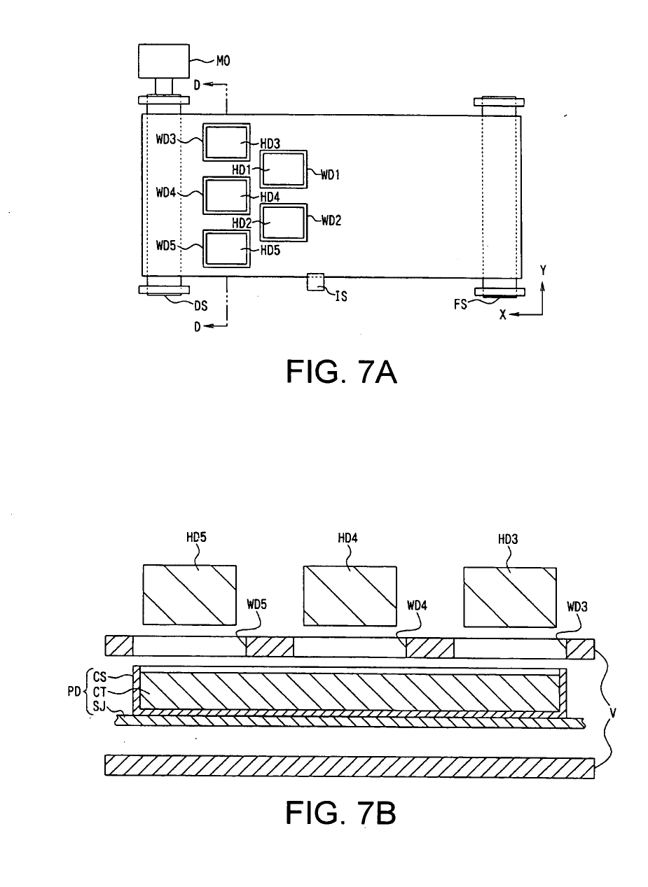

When the counted time comes to a time in which each opening part WD1 to WD5 is opposed to each recording head HD1 to HD5 as shown in FIG. 7A, the CPU sends an instruction for the clogging preventing ejection to the recording head control part HDD.

The recording head control part HDD, on the basis of the instruction for the clogging preventing ejection, controls the recording heads HD1 to HD5, and as shown in FIG. 7B, which is a sectional view along the line D-D in FIG. 7A, causes the recording heads HD1 to HD5 to eject ink droplets through the respective opening parts WD1 to WD5 toward the ink absorber CT of the ink absorbing part PD from the nozzles NZY, NZM, NZC, and NZK.

Here, the opening shape of each opening part WD1 to WD5 is set larger than the shape of the nozzle surface NZP of each recording head HD1 to HD5. Namely, in a state where each recording head HD1 to HD5 is opposed to each opening part WD1 to WD5, the ink droplets ejected from the nozzles NZY, NZM, NZC, and NZK can pass through each opening part WD1 to WD5 without attaching onto the transporting belt V.

When the ink droplet is ejected toward the ink absorber CT, any of the following modes may be adopted: the drive of the transporting part drive motor MO may be stopped to stop the transporting belt V from turning; the turn speed may be decreased without stopping the transporting belt V from turning; or the turn speed of the transporting belt V may be kept constant during the clogging preventing ejection operation. Further, as shown in FIG. 7B, to facilitate easy understanding of the invention, the recording heads HD3 to HD5 and the opening parts WD3 to WD5 are shown, and the downstream side in the X-direction from the drive shaft DS is omitted.

In the ink jet printer 1, in order to prevent clogging when recording is continuously performed on different recording papers P, between-paper clogging preventing ejections may be performed. In this manner, ink droplets are ejected from the recording heads HD1 to HD5 between the different recording papers P regardless of recording. Next, the between-paper clogging preventing ejection will be described.

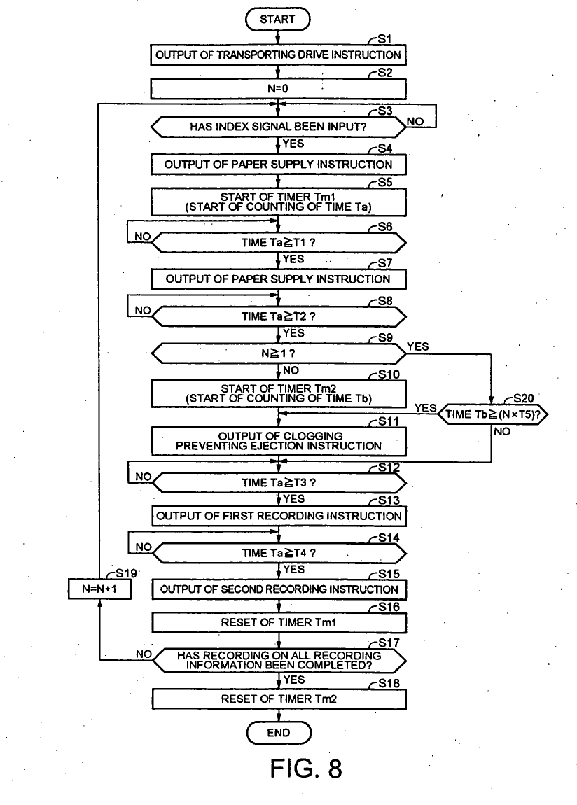

In the ink jet printer 1, upon receipt of the recording instruction and the recording information from the external apparatus, the CPU starts the between-paper clogging preventing ejection shown in FIG. 8.

Firstly, in a step S1, a transporting part drive instruction is output to the motor control part MD, the transporting part drive motor MO is driven so as to turn the transporting belt V counterclockwise, and the operation proceeds to a step S2.

In step S2, numeral 0 is substituted in variable N, and the operation proceeds to a step S3.

In step S3, whether the index signal has been input or not is judged. In a case where the index signal has been input (In case of YES), the operation proceeds to a step S4. In a case where the index signal has not been input (In case of NO), the operation waits until the index signal is input.

In step S4, the CPU outputs a paper supply instruction to the paper supply control part KSD.

In step S5, a timer Tm1 is started to start counting of a time Ta, and the operation proceeds to a step s6.

In step S6, whether the time Ta counted by the timer Tm1 is a predetermined time T1 or more is judged. In a case where it is the predetermined time T1 or more (In case of YES), the operation proceeds to a step S7. In a case where it is not the predetermined time T1 or more (In case of NO), the operation waits until the time Ta comes to the predetermined time T1 or more.

In step S7, the CPU outputs a paper supply instruction to the gate roller control part GRD, and the operation proceeds to a step S8.

In step S8, whether the time Ta is a predetermined time T2 or more is judged. In a case where the time Ta is judged to be the predetermined time T2 or more (In case of YES), the operation proceeds to a step S9. In a case where the time Ta is judged to be not the predetermined time T2 or more (In case of NO), the operation waits until the time Ta comes to the predetermined time T2 or more.

In step S9, whether the value substituted in variable N is one or more is judged. In a case where the value is judged to be one or more (In case of YES), the operation proceeds to a step S20. In a case where the value is judged to be less than one (In case of NO), the operation proceeds to a step S10.

In step S10, a timer Tm2 is started to start counting of time Tb, and the operation proceeds to a step S11.

In step S11, the CPU outputs a clogging preventing ejection instruction to the recording head control part HDD and the operation proceeds to a step S12.

In step S12, whether the counted time Ta is a predetermined time T3 or more is judged. In a case where it is the predetermined time T3 or more (In case of YES), the operation proceeds to a step S13. In a case where it is not the predetermined time T3 or more (In case of NO), the operation waits until the time Ta comes to the predetermined time T3 or more.

In step S13, the CPU outputs a first recording instruction to the recording head control part HDD to cause the recording heads HD1 and HD2 to start recording, and the operation proceeds to a step S14.

In step S14, whether the counted time Ta is a predetermined time T4 or more is judged. In a case where it is the predetermined time T4 or more (In case of YES), the operation proceeds to a step S15. In a case where it is not the predetermined time T4 or more (In case of NO), the operation waits until the time Ta comes to the predetermined time T4 or more.

In step S15, the CPU outputs a second recording instruction to the recording head control part HDD to cause the recording heads HD3, HD4, and HD5 to start recording, and the operation proceeds to a step S16.

In step S16, the timer Tm1 is reset and the operation proceeds to a step S17.

In step S17, whether recording for all the recording information has been completed is judged. In a case where it is judged that recording has been completed (In case of YES), the operation proceeds to a step S18, and the timer Tm2 is reset in step S18 to complete the proceeding. In a case where it is judged that recording has not been completed (In case of NO), the operation proceeds to a step S19.

In step S19, numeral 1 is added to the variable N to obtain new variable N, and the operation proceeds back to step S3.

In case of YES in step S9, the operation proceeds to step S20. In step S20, whether the time Tb counted by the timer Tm2 is a time obtained by multiplying the value substituted in the variable N by the predetermined time T5, or more is judged. In case of YES, the operation proceeds to step S11; in case of NO, the operation proceeds to step S12.

Here, the judgment of whether the time Tb has come to the time obtained by multiplying the value substituted in the variable N by the predetermined time T5 or more is performed in order to judge whether the predetermined time has passed since the clogging preventing ejection was executed just ahead. In the recording heads HD1 to HD5, the nozzles that are not used in recording can exist. In case that the unused state continues, ink viscosity in the unused nozzle increases so that there is a case that the ink droplet cannot be ejected from that nozzle satisfactorily in recording.

Therefore, after recording on one recording paper P has been completed, when timing in which the opening parts WD1 to WD5 are opposed to the recording heads HD1 to HD5 comes, in a case where the predetermined period has passed since the clogging preventing ejection was executed just ahead, the clogging preventing ejection is executed and thereafter the next recording is performed. Further, in a case where recording on one recording paper P has been completed in a short time, when the predetermined period has not passed since the clogging preventing ejection was executed just ahead, the next recording is performed without executing the clogging preventing ejection in order to prevent wasteful consumption of ink.

In the present embodiment, the recording heads HD1 to HD5 correspond to the fixed head, the opening parts WD1 to WD5 correspond to the clogging preventing ejection opening, and the gate roller GR corresponds to the recording medium supply unit.

According to the above, each opening part WD1 to WD5 provided in the transporting belt V can be opposed to each recording head HD1 to HD5 at the same time. Therefore, ink droplets can be ejected through the opening parts WD1 to WD5 onto the ink absorber CT from all the nozzles of the recording heads HD1 to HD5 at the same time.

As such, the clogging preventing ejection can be completed in a very short time. Therefore, also in a case where recording is continuously performed on the plurality of recording papers P, it is possible to keep the delay of the recording time due to the clogging preventing ejection very low, and good recording quality can be kept until completion of the continuous recording.

Further, since the recording paper P is placed on the transporting belt V so as not to be laid on the opening parts WD1 to WD5, it is possible to suppress distortion of the recording paper P caused in a case where the recording paper P is laid on the opening parts WD1 to WD. Further, even in a case where recording on the plurality of recording papers P is continuously performed, every time recording on one recording paper P is completed, timing for the clogging preventing ejection can be provided. Therefore, the distance from each recording head HD1 to HD5 to the recording paper P is kept uniform, deterioration of recording quality is suppressed, and ink ejecting performance of the nozzle can be kept in good order without releasing the timing of the clogging preventing ejection, until the continuous recording is completed.

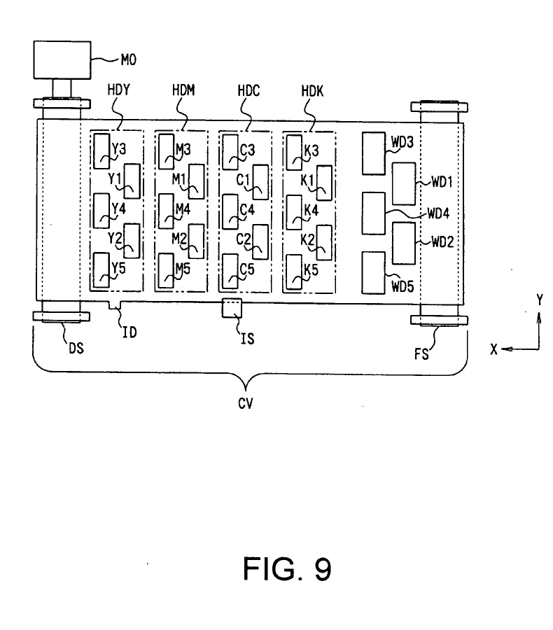

In the present embodiment, the fixed head comprises the recording heads HD1 to HD5, each head having the yellow nozzle NZY, the magenta nozzle NZM, the cyan nozzle NZC, and the black nozzle NZK which eject the ink droplets of yellow, magenta, cyan, and black. However, the invention should not be limited to this configuration. Namely, as shown in FIG. 9, the fixed head may comprise a yellow recording head HDY, a magenta recording head HDM, a cyan recording head HDC, and a black recording head HDK.

According to this constitution, the area of the nozzle surface of each head Y1-Y5, M1-M5, C1-C5, K1-K5 can be reduced. Therefore, correspondingly, the opening area of each opening part HD1 to HD5 can be also reduced. As a result, deformation of the transporting belt V produced by tension can be reduced, which can contribute more to the improvement of the recording quality.

Further, in the present embodiment, the between-paper clogging preventing ejection is performed after recording on one recording paper P has completed, when a time in which the opening parts WD1 to WD5 are opposed to the recording heads HD1 to HD5 comes, in case that the predetermined time has passed since the clogging preventing ejection was executed just ahead. However, the invention is not limited to this, but the between-paper clogging preventing ejection may be performed every time recording on one recording paper P is completed.

In this case, in the between-paper clogging preventing ejection processing shown in FIG. 8, the steps S2, S9, S10, S18, S19, and S20 can be omitted, and the time necessary for the processing can be reduced.

Further, in the present embodiment, an example in which the index part ID is formed convexly in plane is shown. However, the invention is not limited to such a configuration, and the index part ID may be formed concavely. According to this constitution, an extrusion part extending convexly from the side edge of the transporting belt V can be removed, and the size of the paper transporting part CV can be reduced.

Further, in the embodiment, the index sensor IS is composed of the optical sensor having the light emitting element and the light receiving element. However, the invention is not limited to this configuration, and a magnetic sensor or an electrostatic capacity sensor can be adopted.

Further, the relative position between the index part ID and the opening part WD1 to WD5, and the position of the index sensor IS are not limited to the positions shown in the embodiment. That is, their positions may be set so that the index signal is output when the opening parts WD1 to WD5 are opposed to the recording heads HD1 to HD5.

By such a setting, without waiting for the predetermined time since the index signal was output, the clogging preventing ejection can be executed.

Further, in the present embodiment, the index part ID and the index sensor IS are provided as one set, on the downside of the transporting belt V in FIG. 1A. However, the invention is not limited to this configuration. On the downside and upside of the transporting belt V, the index part ID and the index sensor IS may be provided one set by one set. In this case, one set is used in counting the time for the clogging preventing ejection, and the other set is used in counting of the paper supply time.

According to this constitution, the between-paper clogging preventing ejection processing can be separated from the recording processing and the clogging preventing ejection processing, so that a load of the between-paper clogging preventing ejection processing applied on the CPU can be reduced.

Further, also in a case where there are the above-described two kinds of index parts ID; the convex and the concave index parts in plane are formed in a row in the X-direction on either side of the downside and the upside of the transporting belt V, one of the convex and the concave index parts ID is used in counting of timing of the clogging preventing ejection, and the other is used in counting of paper supply timing, the effects similar to the above effects can be obtained.

1. An ink jet printer comprising:
a fixed head arranged opposite a recording surface, the recording surface opposing a transporting surface of a recording medium placed on a transporting belt; and
a recording area formed by arranging a plurality of nozzles for ejecting ink droplets in a direction that intersects a transporting direction of the recording medium,
wherein the transporting belt has a clogging preventing ejection opening opposed to the fixed head at a predetermined time while the transporting belt travels in the transporting direction; and
the recording medium is arranged on the transporting belt spaced from the clogging preventing ejection opening.

2. The ink jet printer according to claim 1, further comprising:
an opening position detecting unit that detects a position of the clogging preventing ejection opening in the transporting direction; and
a recording medium supply unit that supplies the recording medium on the transporting belt at a time in which the position detected by the opening position detecting unit travels on a downstream side of a supply position of the recording medium.

3. The ink jet printer according to claim 2, wherein the opening position detecting unit comprises an index part formed at one side edge of the transporting belt, and an index sensor for detecting the index part.

4. The ink jet printer according to claim 3, wherein the index sensor comprises an optical sensor having a light emitting element and a light receiving element.

5. The ink jet printer according to claim 1, wherein the fixed head includes a plurality recording heads each having the plurality of nozzles arranged at a predetermined length, the nozzles being arranged in a direction that intersects the transporting direction of the recording medium; and
the plurality of clogging preventing ejection openings are arranged in a direction that intersects the transporting direction of the recording medium so that the openings, each of which is opposed to at least one of the plurality recording heads that constitute the recording areas at the predetermined time.

6. The ink jet printer according to claim 5, wherein the opening part is provided for each of the plurality recording heads that constitute the recording area.

7. The ink jet printer according to claim 5, wherein the opening part is formed symmetrically with a center line in a width direction that intersects the transporting direction of the transporting belt.
